(19) United States
(12) Patent Application Publication
(10) Pub. No.: US 2007/0091395 A1
(43) Pub. Date: Apr. 26, 2007

(54) Device and method for measuring and determining the quality of holographic image

(76) Inventors: Salvatore D'Amato, Monmouth Beach, NJ (US); Lily O'Boyle, Cream Ridge, NJ (US); Ron McClenny, Tuscalaoosa, AL (US); Richard S. Conarroe, Wyncote, PA (US); John Hynes, Reisterstown, MD (US)

Correspondence Address: FULBRIGHT & JAWORSKI, LLP, 666 FIFTH AVE, NEW YORK, NY, 10103-3198, US

(21) Appl. No.: 11/500,551

(22) Filed: Aug. 7, 2006

Related U.S. Application Data
(60) Provisional application No. 60/706,080, filed on Aug. 5, 2005.

(51) Int. Cl. G03H 1/08

(52) U.S. Cl. 359/9

(57) ABSTRACT

The apparatus and method of the present invention measures diffracted or scattered light to determine the quality of the holographic images/items that have been transferred or reproduced to a film based media. The apparatus comprises one or more illumination and detection devices which illuminate light (e.g., laser) onto the holographic images/items, detect and collect diffracted/scattered light to perform quality inspection of the holographic images/items during a web based holographic manufacturing process.

### RELATED APPLICATIONS

This application claims priority from provisional application No. 60/706,080 filed Aug. 5, 2005, incorporated by reference in its entirety.

### BACKGROUND OF THE INVENTION

The present invention relates to a quality inspection apparatus and method for inspecting quality of holographic images/items, which are well known in the anti-counterfeiting industry. Traditional quality inspection methods require shutting down the holographic image/item manufacturing process and removing a portion of the holographic image or item to enable a quality control expert or computer to measure the quality of the removed holographic image/item. After removal and inspection of the holographic image/item for quality assurance, the image/item is unusable and typically discarded. The present invention proceeds upon the desirability of addressing these problems and limitations associated with the typical procedure including unwelcome manufacturing downtime, creation of waste (unusable products), and a decrease in manufacturing yield. These undesirable conditions are avoided with the quality inspection apparatus and method of the present invention.

### OBJECT AND SUMMARY OF THE INVENTION

Therefore, it is an object of the present invention to provide an improved and novel apparatus and method which avoids these aforementioned problems with the conventional apparatus and method.

Another object of the present invention to provide an apparatus and method for inline quality inspection of holographic images/items (e.g., a holographic image that has been transferred or reproduced to a film based media), which minimizes manufacturing downtime and waste (unusable products). In accordance with an embodiment of the present invention, there is no need for a portion of an item to be removed, in order for a quality control expert or computer to measure the quality of the holographic image. The present invention permits the measurement to be taken real time “on the fly,” permitting a smooth non-stop manufacturing operation.

A further object of the present invention is to provide an apparatus and method which computes the quantity of holographic images/items produced, e.g., per large sheet of film based media.

A still another object of the present invention is to provide an apparatus and method, as aforesaid, which can additionally detect a condition (i.e., a worn out component) of the manufacturing system used to produce the holographic images/items. In accordance with an exemplary embodiment of the present invention, the apparatus and method provides an alert and warning when a worn out component is detected. An operator of the manufacturing system upon receiving the alert/warning can schedule maintenance to address the problem or if the problem is severe, can shut down the manufacturing system to repair and/or replace the worn out component, e.g., embossing shim, thereby preventing waste and increasing manufacturing efficiency.

A yet another object of the present invention is to provide an apparatus and method, as aforesaid, which can record the adjustments made to the manufacturing system and the results of the adjustments can be displayed in statistical or other graphical summary displays.

In accordance with an embodiment of the present invention, the apparatus and method measures diffracted or scattered light to determine the quality of the holographic images/items that have been transferred or reproduced to a film based media. The present apparatus and method comprises one or more illumination and detection devices which illuminate light (e.g., laser) onto the holographic images/items, detect and collect diffracted/scattered light to perform quality inspection of the holographic images/items during a web based holographic manufacturing process.

In accordance with an exemplary embodiment of the present invention, the holographic image incorporates a diffraction grated section or sections (e.g., ABNH's HoloMag image), which can be easily identified and repeated in a predetermined pattern on large sheets of film based media, to be detected and evaluated by the quality inspection apparatus and method. The diffraction detector (detectors) and light source (sources) are aligned to receive the diffracted or scattered light from the replicated microstructures. A variation of the amplitude detected by the detector(s) is generally related to the fidelity of the reproduction. Hence, the quality of the reproduction is closely associated with the amplitude of the signal detected from the diffraction grating(s) or scattering surface(s). The present apparatus and method can display the detected amplitude on a display screen to allow a machine operator to observe and interpret changes in the manufacturing process and make any necessary adjustments (e.g., to the pressure and temperature of the embossing or other reproduction process). Additionally, the end result of the operator's adjustments can be displayed on a display screen. The pre-adjustment and post-adjustment readings can be displayed on the display screen or printed.

In accordance with an exemplary embodiment of the present invention, the apparatus comprises a computer or processing system for receiving the amplitude readings set up in a feedback configuration with the quality inspection apparatus. The computer can record and interpret the process changes based on the amplitude readings. Preferably, the computer makes the necessary adjustments automatically (e.g., to the pressure and temperature of the embossing or other reproduction process) based on the amplitude readings. The history of amplitude readings (i.e., detection) and machine adjustments/settings can be displayed and stored for further quality statistical analysis.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the present invention solely thereto, will best be understood in conjunction with the accompanying drawings in which:

FIG. 1 depicts an inline quality inspection apparatus in accordance with an exemplary embodiment of the present invention;

FIG. 2 depicts an operator control panel which operates in conjunction with the quality inspection apparatus of the present invention;

FIG. 3 shows two diffraction detectors and the light source components in accordance with an exemplary embodiment of the present invention;

FIGS. 4 and 6 depict examples of amplitude reading measurements over time from the quality inspection apparatus of the present invention; and

FIG. 5 depicts a pair of sensors which display real time amplitude readings in accordance with an exemplary embodiment of the present invention.

### DETAILED DESCRIPTION OF THE INVENTION

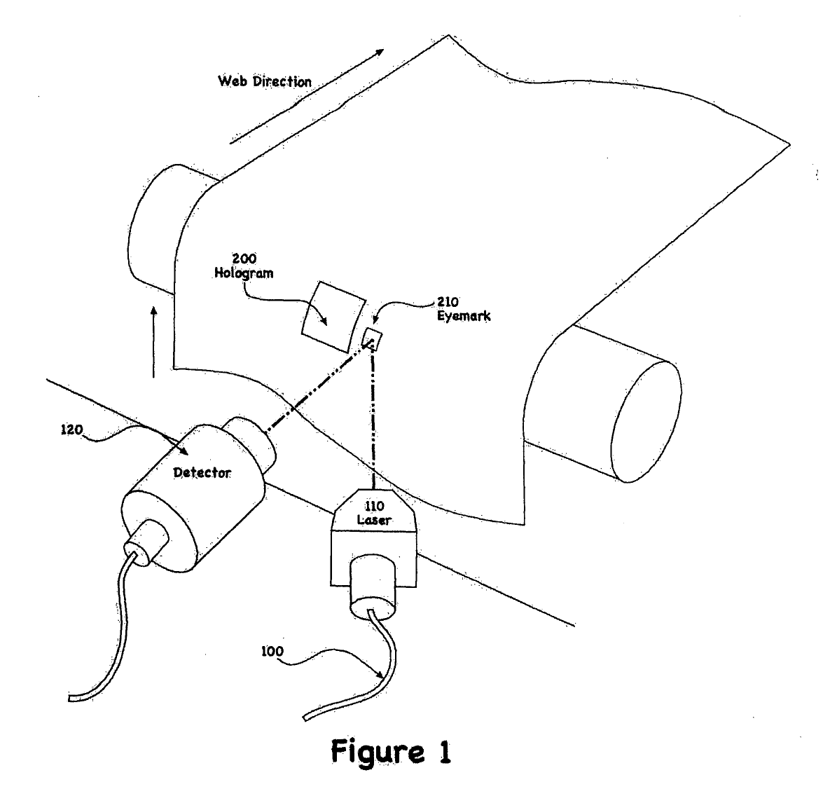

Turning to FIG. 1, in accordance with an exemplary embodiment of the present invention, there is illustrated an apparatus for inline monitoring of a production film 200 comprising a plurality of microstructure based images 210. The quality inspection apparatus 100 comprises a light source 110, a detector 120 and a processor or computer 130. The light source 110, e.g., a laser, is directed to one or more microstructure based images 210 on the production film 200 to monitor the quality of the plurality of microstructure based images 210 on the production film 200. The detector 120 for detecting light rays diffracted or scattered by the microstructure based image 210. The processor or computer 130 for determining optical characteristics of the microstructure based image 210 based on the diffracted or scattered light rays. The present invention performs inline quality inspection of holographic images/items via the microstructure based images 210 on the production film 200. This advantageously minimizes manufacturing downtime and waste (unusable products). Unlike the conventional method, there is no need to remove a portion of the holographic image/item from the production film 200 in order for a quality control expert or computer 130 to measure the quality of the holographic image on the production film 200. That is, the present invention permits the measurement to be taken real time “on the fly,” permitting a smooth non-stop manufacturing operation.

In accordance with an exemplary embodiment of the present invention, the production film 200 containing holographic images incorporates diffraction grated sections or microstructures 210, which can be easily identified and repeated in a predetermined pattern on large sheets of film based media (i.e., the production film 200). The diffraction grated sections or microstructures 210 can be readily detected and evaluated by the quality inspection apparatus 100 and method of the present invention. The diffraction detector(s) 120 and light source(s) 110 are aligned to receive the diffracted or scattered light from the replicated microstructures 210.

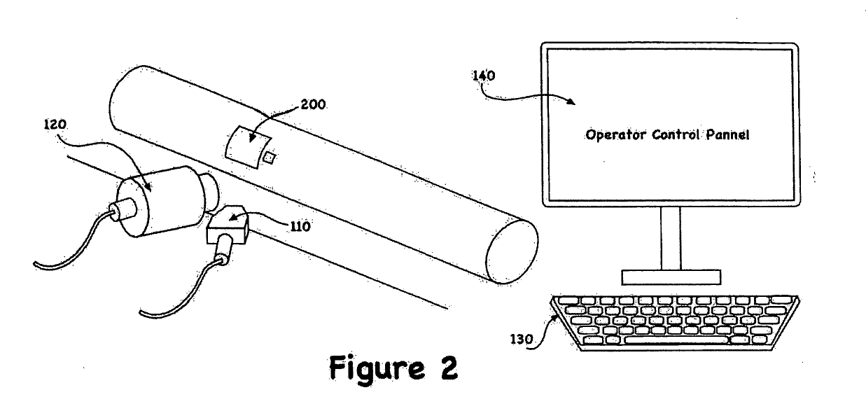

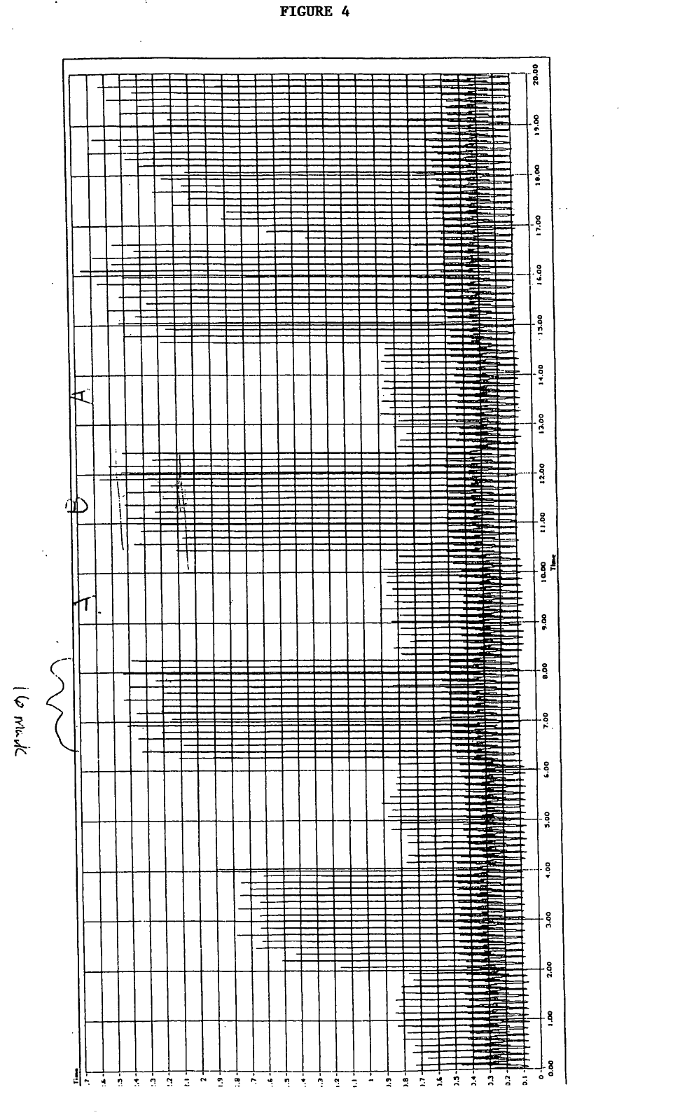

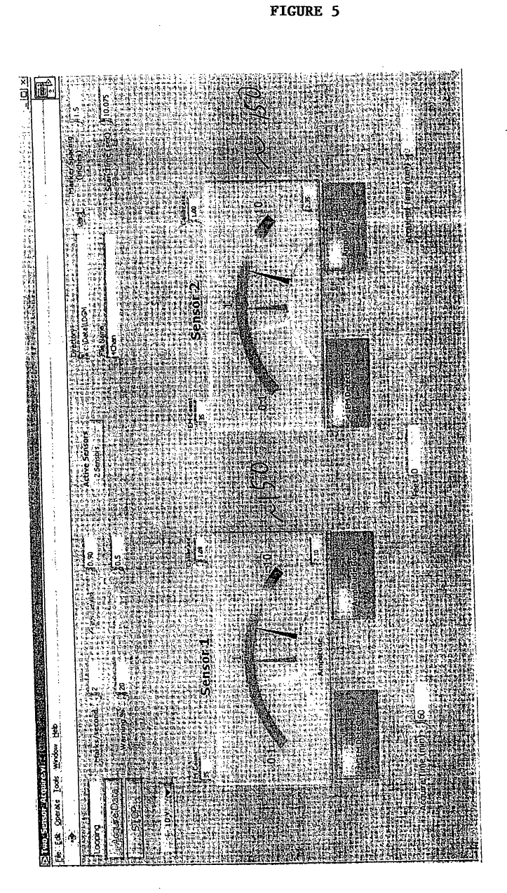

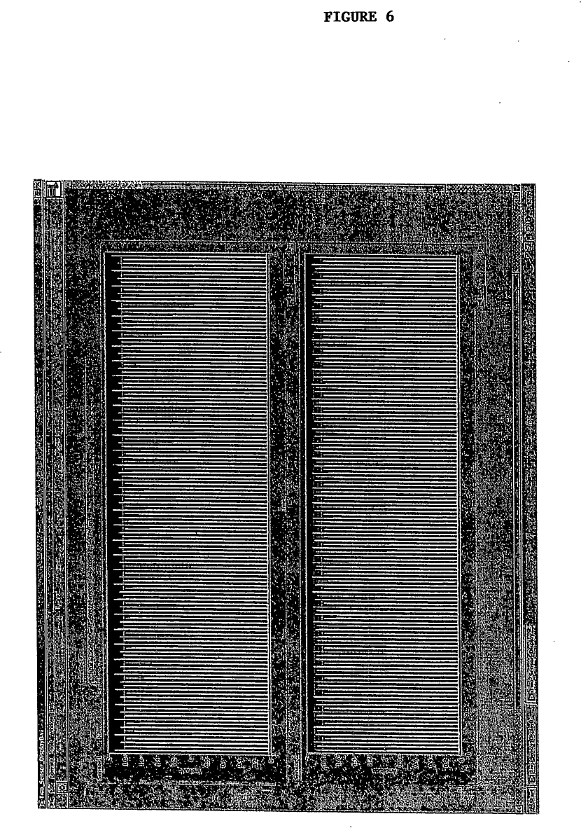

The detector(s) 120 detects the amplitude of the diffracted or scatter light from the grated section(s) or microstructures 210. The variation of the detected amplitude is generally related to the fidelity (i.e., optical brightness) of the reproduction of the microstructure based images (i.e., holographic reproduction of the production film 200). Hence, the quality of the production film 200 is closely associated with the amplitude of the signal detected from the diffraction gratings, scattering surfaces or microstructures 210. A decrease in the detected amplitude of the diffracted or scattered light generally relates to a degradation of the production film 200 (i.e., degradation in quality of the microstructure based holographic images/items). The present apparatus and method can display the detected amplitude in real time on an operator control panel or display screen 140, which can be a connected to a computer 130, shown in FIG. 2, to allow a machine operator to observe and interpret changes in the manufacturing process and make any necessary adjustments (e.g., to the pressure and temperature of the embossing or other reproduction process). In accordance with an aspect of the present invention, the display screen 140 displays the real time amplitude readings over time measured by a pair of sensors 150, as shown in FIG. 5. Examples of the amplitude readings over time are depicted in FIGS. 4 and 6. Additionally, the end result of the operator's adjustments can be displayed on a display screen 140. The pre-adjustment and post-adjustment readings can be displayed on the display screen 140 or printed.

In accordance with an embodiment of the present invention, the quality inspection apparatus 100 is connected to a sensor 150 which displays real time amplitude readings, as shown in FIG. 5. The sensor 150 is operable to record the manufacturing history of the holographic image/item and to detect preset minimum and maximum amplitude threshold levels. If one of the threshold levels is detected, the quality inspection apparatus 100 can notify (e.g., visually or audibly) the operator an operator to make appropriate adjustments (e.g., to the pressure and temperature of the reproduction process) to the manufacturing or holographic reproduction apparatus. In accordance with an exemplary embodiment of the present invention, the processor computer 130 is operable to generate an alert signal in real time to notify an operator of a holographic reproduction apparatus (manufacturing apparatus) to make adjustments to the holographic reproduction apparatus based on the detected optical characteristics to optimize the manufacture of the production film. In accordance with an aspect of the present invention, the computer 130 connected to the quality inspection apparatus 100 can automatically make the adjustments based on the detected threshold levels and the sensor data. Alternatively, no adjustments can be made and the sensor data can be stored for future reference. It is appreciated that the sensor data can be stored regardless whether any adjustments are made to the manufacturing system. As shown in FIGS. 4 and 6, the sensor data can be plotted on any type of graph or histogram.

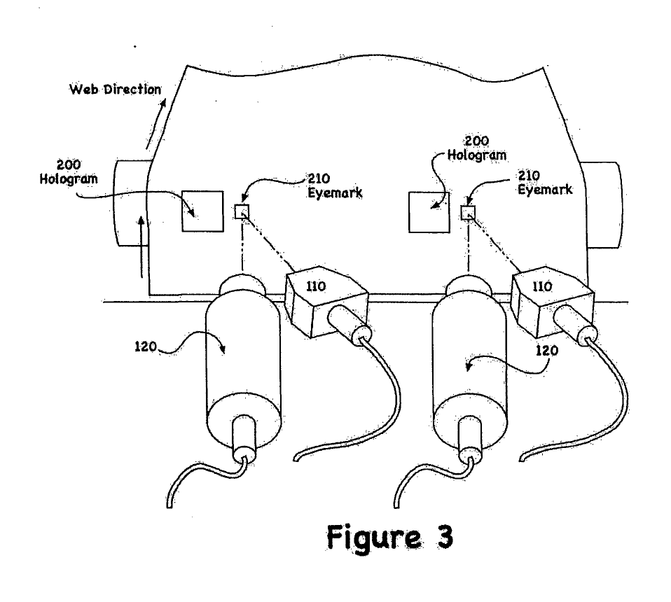

Turning now to FIG. 3, in accordance with an exemplary embodiment of the present invention, there is illustrated the quality inspection apparatus comprising two diffraction detectors 120 and two light sources 110 positioned in front of diffraction grating blocks 210 on a web of holographic film 200. In accordance with an aspect of the present invention, multiple detectors 120 and multiple light sources 130 can be positioned across the width of the holographic film web 200 to sample more points for higher quality control.

In accordance with an embodiment of the present invention, since the diffraction rating sections or microstructures 210 are repeated in a predetermined pattern on the production film 200, the present quality inspection apparatus and method can compute the quality of holographic images/items produced, e.g., per large sheet of film based media or production film 200, by counting the number of the microstructures 210 detected from the production film 200.

In accordance with an exemplary embodiment of the present invention, based on the quality inspection of the microstructures 210 on the production film 200, the present quality inspection apparatus and method can additionally detect or determine the condition (i.e., a worn out component) of the manufacturing system used to produce the holographic images/items. The present apparatus and method provides an alert and warning when a worn out component is detected. An operator of the manufacturing system upon receiving the alert/warning can schedule maintenance to address the problem or if the problem is severe, can shut down the manufacturing system to repair and/or replace the worn out component, e.g., embossing shim, thereby preventing waste and increasing the manufacturing efficiency.

In accordance with an embodiment of the present invention, the quality inspection apparatus and method measures diffracted or scattered light to determine the quality of the holographic images/items that have been transferred or reproduced to a film based media. The present apparatus and method comprises one or more illumination and detection devices which illuminate light (e.g., laser) onto the holographic images/items, detect and collect diffracted/scattered light to perform quality inspection of the holographic images/items during a web based holographic manufacturing process.

In accordance with an exemplary embodiment of the present invention, the apparatus comprises a computer or processing system for receiving the amplitude readings set up in a feedback configuration with the quality inspection apparatus. The computer can record and interpret the process changes based on the received amplitude readings. Preferably, the computer makes the necessary adjustments automatically (e.g., to the pressure and temperature of the embossing or other reproduction process) based on the amplitude readings. The history of amplitude readings (i.e., detection) and machine adjustments/settings can be displayed and stored for further quality statistical analysis.

In accordance with an embodiment of the present invention, the method monitors the production film comprising a plurality of microstructure based images. The present inline monitoring method comprises the steps of directing a light source on to a microstructure based image on the production film to monitor the quality of the microstructure based images on the production film; detecting light rays diffracted or scattered by the microstructure based images; and determining optical characteristics of the microstructure based images as a function of the amplitude of the diffracted or scattered light rays.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, and composition of matter, means, methods and steps described herein. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. Apparatus for inline monitoring of a production film comprising a plurality of microstructure based images, the apparatus comprising:
a light source directed to a microstructure based image on said production film to monitor the quality of said plurality of microstructure based images on said production film;
a detector for detecting light rays diffracted or scattered by said microstructure based image; and
a processor for determining optical characteristics of said microstructure based image based on said diffracted or scattered light rays.

2. The apparatus of claim 1, further comprising a display device for displaying said optical characteristics of said microstructure based image.

3. The apparatus of claim 1, wherein said processor is operable to generate an alert signal in real time to notify an operator of a holographic reproduction apparatus to make adjustments to said holographic reproduction apparatus based on said optical characteristics to optimize the manufacture of said production film.

4. The apparatus of claim 1, wherein one of said optical characteristics is amplitude of said diffracted or scattered light rays; and wherein said processor is operable to determine a variation in said amplitude.

5. The apparatus of claim 1, wherein said production film comprises a plurality of holographic images and wherein said processor is operable to monitor the quality of said holographic image based on said optical characteristics.

6. The apparatus of claim 1, wherein said processor is operable to detect degradation in said plurality of microstructure based images on said production film based on said optical characteristics.

7. The apparatus of claim 1, further comprising a storage device for storing said optical characteristics determined by said processor.

8. The apparatus of claim 1, further comprising a plurality of light sources and a plurality of detectors.

9. The apparatus of claim 1, wherein said processor is operable to modify a manufacturing process parameter of said production film based on said optical characteristics.

10. The apparatus of claim 9, wherein said manufacturing process parameters comprises at least one of the following: temperature and pressure.

11. The apparatus of claim 1, wherein said microstructure based image is a diffraction grated section which is repeated/reproduced in a predetermined pattern on said production film.

12. The apparatus of claim 1, wherein said image is a volume based holographic section which is repeated and reproduced in a predetermined pattern on said production film.

13. The apparatus of claim 1, wherein one of said optical characteristics is optical brightness of said microstructure based image.

14. The apparatus of claim 1, wherein said processor is operable to determine the quantity of holographic images/items reproduced on said production film based on the number of said microstructure based image detected by said detector.

15. The apparatus of claim 1, wherein said processor is operable to determine a condition of one or more components of a holographic reproduction apparatus based on said optical characteristics of said microstructure based image.

16. The apparatus of claim 15, wherein said processor is operable to generate an alert signal in real time to notify an operator of a holographic reproduction apparatus to schedule maintenance or replace a worn out component of said holographic reproduction apparatus if it is determined that one or more components of said holographic reproduction apparatus is worn out.

17. A method for inline monitoring of a production film comprising a plurality of microstructure based images, the method comprising the steps of:
directing a light source on to a microstructure based image on said production film to monitor the quality of said microstructure based images on said production film;
detecting light rays diffracted or scattered by said microstructure based image; and
determining optical characteristics of said microstructure based image based on said diffracted or scattered light rays.

18. The method of claim 17, wherein said production film comprises a plurality of holographic images, further comprising the steps of monitoring the quality of said holographic image based on said optical characteristics and displaying said optical characteristics of said microstructure based image.

19. The method of claim 17, further comprising the step of notifying an operator of a holographic reproduction apparatus in real time to make adjustments to said holographic reproduction apparatus based on said optical characteristics to optimize the manufacture of said production film.

20. The method of claim 17, wherein the step of detecting comprises the step of measuring amplitude of said diffracted or scattered light rays; and further comprising the step of determining a variation in said amplitude.

21. The method of claim 17, further comprising the step of detecting degradation in said plurality of microstructure based images on said production film based on said optical characteristics.

22. The method of claim 17, further comprising the step of storing said optical characteristics.

23. The method of claim 17, further comprising the steps of:
directing light on to a plurality of microstructure based images on said production film to monitor the quality of said microstructure based images on said production film; and
detecting light rays diffracted or scattered by said plurality of microstructure based images.

24. The method of claim 17, further comprising the step of modifying a manufacturing process parameter of said production film based on said optical characteristics.

25. The method of claim 17, further comprising the step of determining the quantity of holographic images/items reproduced on said production film based on the number of said microstructure based image detected.

26. The method of claim 17, further comprising the step of determining a condition of one or more components of a holographic reproduction apparatus based on said optical characteristics of said microstructure based image.

27. The method of claim 26, further comprising the step of generating an alert signal in real time to notify an operator of a holographic reproduction apparatus to schedule maintenance or replace a worn out component of said holographic reproduction apparatus if it is determined that one or more components of said holographic reproduction apparatus is worn out.
